(19) United States
(12) Patent Application Publication
(10) Pub. No.: US 2014/0210221 A1
(43) Pub. Date: Jul. 31, 2014

(54) Vehicle Lock Strike

(71) Applicant: KASON INDUSTRIES, INC., Newnan, GA (US)

(72) Inventors: Brett A. Mitchell, Newnan, GA (US); Thomas A. Thorsen, Wedowee, AL (US)

(73) Assignee: Kason Industries, Inc., Newnan, GA (US)

(21) Appl. No.: 13/751,990

(22) Filed: Jan. 28, 2013

(51) Int. Cl. E05B 65/12

(52) U.S. Cl. CPC E05B 85/04; E05B 85/24
USPC 292/228; 292/340

(57) ABSTRACT

A vehicle lock strike (11) is disclosed for use with a latch (10) for a vehicle sliding door. The latch includes a two pivoting latch bar (16) having at least one pawl (19) with a stop surface (23). The lock strike includes a main plate (31) having a locking wall (33) with a L-shaped tang (35) which has an inwardly facing catch surface (36), a top surface (37), and an outwardly facing gap surface (38). The lock strike also includes a second plate (41) coupled to the locking wall having a top end surface (47), and an inwardly facing catch surface (48). A gap (50) is created between the tang and the second plate to receive a lower portion of the pawl. The top of the second plate is positioned higher than the top of the locking wall.

### TECHNICAL FIELD

This invention relates to lock strikes, and specifically to a lock strike which in incorporated into the sliding door of a vehicle.

### BACKGROUND OF INVENTION

Vehicles, especially vans and delivery trucks, include sliding side doors which enable access to the interior. These sliding doors have a lock set which includes a latch mounted to the sliding door itself and a strike or strike plate mounted to the stationary sidewall or door jamb of the vehicle. The latch typically includes a catch which contacts and grasps onto a portion of the strike.

Lock sets having pivoting catch tongues have proven to be better than those having rotary tongues, as the pivoting tongue rides upon or floats upon the strike rather than tightly capturing the strike. This floating motion reduces the wear due to frictional contact between the tongue and strike vehicle vibration.

Another problem associated with lock sets is that on occasion the door may accidently slide to an open position if the lock set is not properly set or if a large enough force is placed upon it. As such, recently government regulations have mandated that vehicle lock sets include two stage latching capabilities to restrict accidental full opening of the door.

Accordingly, it is seen that a need exists for lock set strikes for a vehicle that includes a two-stage latching. It is to the provision of such therefore that exemplary embodiments of the present invention are primarily directed.

### SUMMARY OF INVENTION

A vehicle lock strike for a latch having a reciprocally moving latch bar having a pawl comprises a main plate including a locking wall having a select height, and a second plate positioned closely adjacent to the locking wall and having a select height greater than the select height of the locking wall. With this construction, the latch lockably abuts the locking wall in a first position and lockably abuts the second plate in a second position.

### BRIEF DESCRIPTION OF DRAWINGS

FIG. 1 is a perspective view of a vehicle lock strike and sliding door latch in a preferred form of the invention, shown in a fully locked position.

FIG. 2 is a perspective view of the vehicle lock strike and sliding door latch of FIG. 1, shown in a semi-locked position.

FIGS. 3-7 are front views showing the vehicle lock strike and sliding door latch of FIG. 1 illustrating the sequential locking and unlocking positions of the sliding door latch.

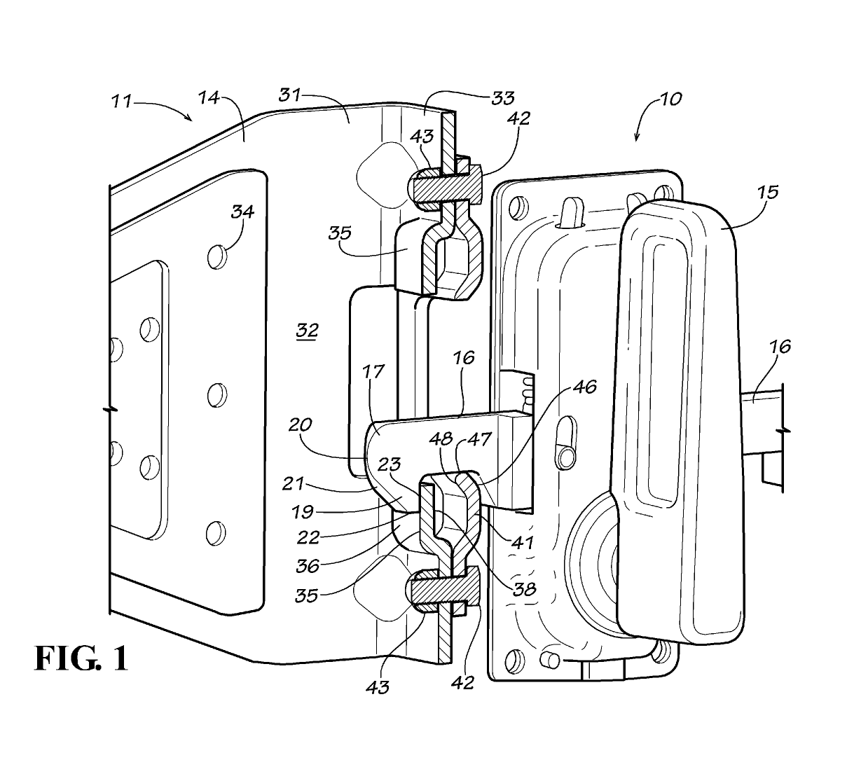

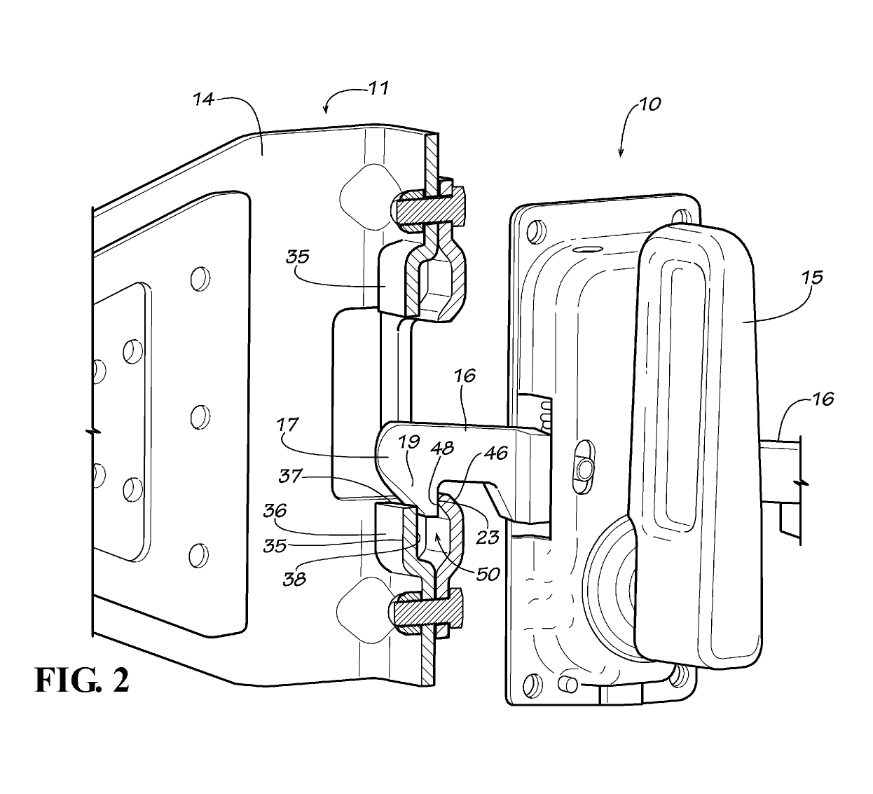

### DETAILED DESCRIPTION

With reference to the drawings, there is shown a latch 10 for a vehicle sliding door and a lock strike 11 embodying principles of the invention in a preferred form. The latch 10 is mounted to the sliding door of the vehicle while the lock strike is mounted to the stationary door jamb portion of the vehicle. The latch 10 may be the same as that shown in U.S. Pat. No. 5,979,949 the entire contents of which are commonly owned and incorporated herein by reference. The latch may also be one of the models sold under the model designation 4000 series by Kason Industries, Inc. of Shenandoah, Ga. In particular, the latch 10 includes a housing 14, a rotatable handle 15, and a latch bar 16 operably coupled with the handle so that the actuation of the handle causes one side of the latch bar to pivot upwardly against the spring biasing force placed upon the latch bar. The latch bar 16 has two oppositely disposed notches or catches 17 each of which defines a pawl 19 having a rounded end surface 20, an inclined camming surface 21, a bottom surface 22, and an inwardly facing stop surface 23.

The lock strike 11 includes a main plate 31 having a mounting wall or portion 32 and a locking wall or portion 33 extending generally perpendicular to the mounting wall 32. The mounting wall 32 has a plurality of mounting holes 34 which enable the lock strike 11 to be mounted to the vehicle body or jamb with corresponding bolts. The locking wall 33 includes a L-shaped tang 35 which has an inwardly facing catch surface 36, a top surface 37, and an outwardly facing gap surface 38.

The lock strike 11 also includes an auxiliary or second plate 41 coupled to the locking wall 33 through two bolts 42 and nuts 43. Alternatively, the second plate 41 may be coupled in any conventional fashion such as with welding or forming a second tang from either the mounting wall 32 or locking wall 33. The second plate 41 includes a top camming surface 46, a top end surface 47, and an inwardly facing catch surface 48. The second plate 41 is configured and mounted so that a gap 50 is created between the tang 35 and the second plate 41, i.e., a gap 50 exists between the tang gap surface 38 and the second plate catch surface 48. The top of the second plate 41 is positioned higher than the top of the locking wall 33. The gap 50 is configured to receive a lower portion of the pawl 19, as describe in more detail hereinafter.

It should be noted that the lock strike 11 is symmetrical about a horizontally extending centerline so that the lock strike may be inverted for either right or left sliding vehicle doors. Also, the lock strike has two opposing catches so that it is not only mountable on either side of the vehicle, but that it is also utilized with a second strike to maintain the door in an open position, i.e., one lock catch is coupled to one strike in a door closed position and the other lock catch is coupled to the second strike in a door fully open position to prevent the door from sliding from the fully opened position. The following description will refer to the door being locked in a closed position, however, the same description also is utilized for a locked fully open door position.

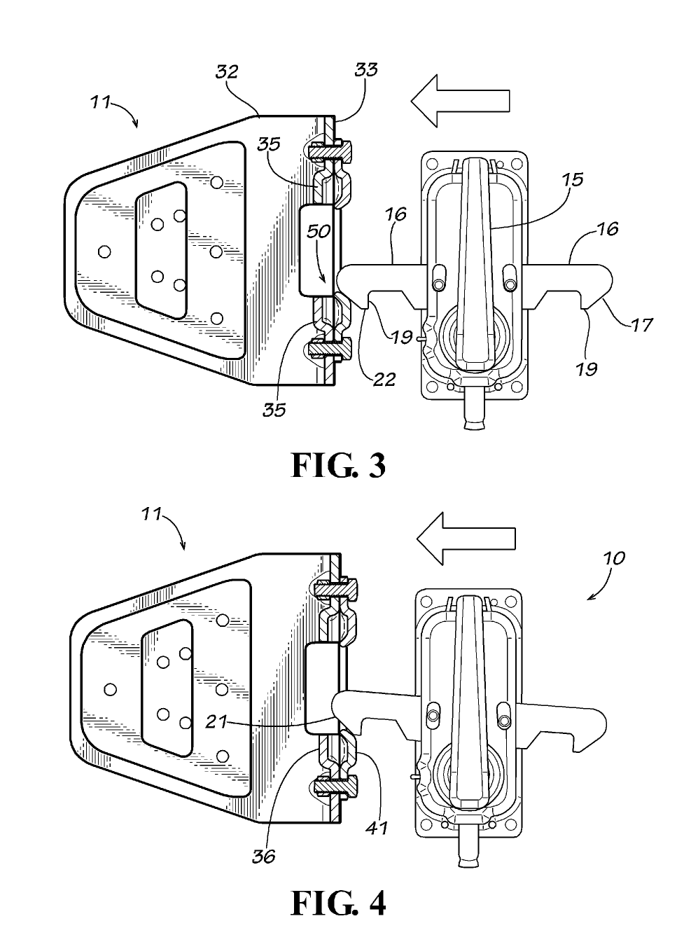

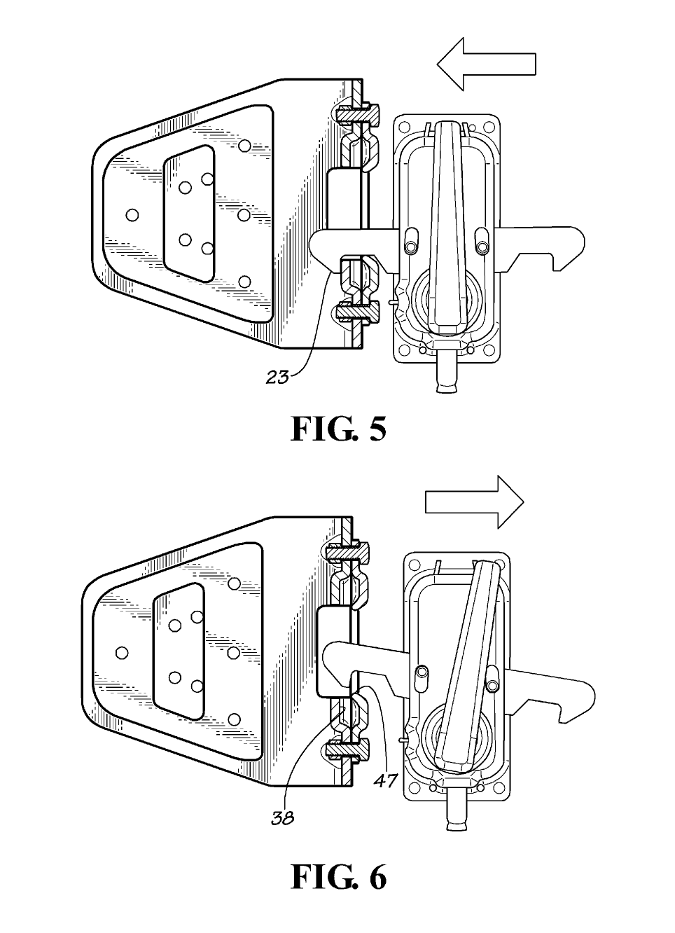

In use, as the sliding door is moved to a locked position the pawl inclined camming surface 21 contacts the second plate top camming surface 46, as shown in FIG. 3. With continued sliding movement of the door the pawl pivots upwardly and continues to ride upon the two surfaces 21 and 46, as shown in FIG. 4, until the pawl completely passes the second plate 41 and tang 35, as shown in FIG. 5. With the pawl in this first locked position, the pawl stop surface 23 lockably abuts the tang catch surface 36, thereby locking the relative position of the lock strike to the latch 10 and locking the door in its closed position. With the pawl in this engaged or locked position, the door should be locked securely so that it does not move to its open position.

Should one wish to open the door the handle is rotated thereby pivotally raising one end of the latch bar 26 depending on which direction the handle is rotated, as shown in FIG. 6. It should be noted that the latch bar 26 adjacent the lock strike 11 is raised sufficiently to allow the pawl bottom surface 22 to clear or pass over the tang top surface 37 and second plate top end surface 47, thereby allowing unencumbered movement of the sliding door.

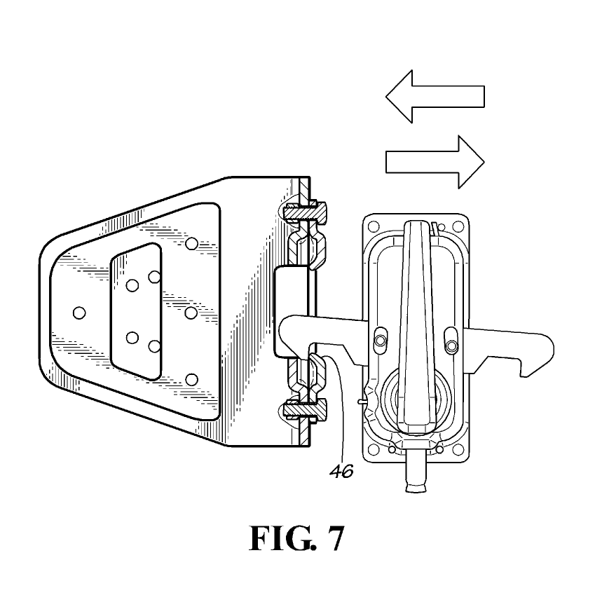

However, should the door be accidentally moved from its first locked position in the open direction, shown toward the right in FIG. 7, the pawl stop surface 23 has accidently disengaged from the tang catch surface 36. However, if such an accidental opening occurs, the downward spring biasing force placed upon the latch bar 16 causes the lower portion of the pawl 19 (the pawl tooth) to be moved into the gap 50 between the tang 35 and second plate 41, as shown in FIG. 7. With the pawl 19 in this semi-locked or second locked position the door movement is arrested as the pawl stop surface 23 contacts and lockably abuts the second plate catch surface 48. As such, it should be understood that the latch 10 is stopped in two separate and distinct locations, the first being against the locking wall 33 and the second being against the second plate 41.

It is believed that the similar results may be achieved by having the top of the second plate a height greater than the top of the locking wall 33, as shown in the preferred embodiment, without the need for a gap therebetween. However, while the present invention covers such an alternative, this is not preferred as it is believed that the presence of the gap 50 allows the pawl to drop between locking wall 33 and second plate 41, thereby increasing the contact surfaces therebetween and reducing the height difference necessary between locking wall 33 and second plate 41 to arrest accidental door movement. Additionally, the absence of the gap would require a greater height difference between the locking wall and second plate to sufficiently catch the pawl, and thus would require that the latch bar 16 be moved to a higher position during unlocking to clear the latch locking wall 33 and second plate 41.

It should be understood that while the preferred embodiment shows a pivotal latch bar, other types of reciprocally moving latch bars may be included in the present embodiment, such as a latch bar that it moved vertically.

It thus is seen that a lock strike is now provided which overcomes problems associated with lock strikes of the prior art. While this invention has been described in detail with particular reference to the preferred embodiment thereof, it should be understood that many modification, additions and deletions, may be made thereto without departure from the spirit and scope of the invention as set forth in the following claims.

1. A combination vehicle ck strike and latch comprising,
a latch having a housing adapted to be mounted to a vehicle, the latch also having a handle and at least one reciprocally moving latch bar having a generally vertically reciprocating and downwardly extending pawl, and
a lock strike having a main plate including at least a stationary locking wall and a stationary second plate positioned in close proximity to said locking wall, said stationary locking wall having a select vertical height and a catch surface configured to lockably abut said latch pawl when said latch pawl is in a locked position, said second plate having a select vertical height greater than said select vertical height of said locking wall and a catch surface configured to lockably abut said latch pawl when said latch pawl is in a semi-locked position.

2. The combination vehicle lock strike and latch of claim 1 wherein said second plate is spaced from said locking wall to form a gap therebetween configured to receive a portion of said pawl.

3. The combination vehicle lock strike and latch of claim 1 wherein said pawl including a stop surface, and wherein said locking wall has a generally vertical catch surface and said second it has a generally vertical catch surface, a top end surface, and a caroming surface extending to said top end surface, said locking wall catch surface and said second plate catch surface facing said pawl stop surface, and said second plate camming surface being oppositely disposed from said second plate catch surface.

4. The combination vehicle lock strike and latch of claim 1 wherein said main plate also includes a mounting wall extending generally perpendicularly from said locking wall.

5. A vehicle lock strike for a latch having a reciprocally moving latch bar having a generally vertically reciprocating and downwardly extending pawl with a stop surface, the vehicle lock strike comprising,
main plate including a stationary locking wall having a select vertical height and a catch surface adapted to abut said pawl stop surface with the pawl in a first locked position, and
a stationary second plate positioned closely adjacent to said locking wall and having a select vertical height greater than said select vertical height of said locking wall and a catch surface adapted to abut said pawl stop surface with the pawl in a second locked position,
whereby the latch lockably abuts the locking wall in a first position and to lockably abuts the second plate in a second position.

6. The vehicle lock strike of claim 5 wherein. said second plate is spaced from said locking wall to form a gap therebetween configured to receive a portion of the pawl.

7. The vehicle lock strike of claim 5 wherein the pawl including a stop surface, and wherein said locking wall has a generally vertical catch surface and said second plate has a generally vertical catch surface, a top end surface, and a camming surface extending to said top end surface, said locking wall catch surface and said second plate catch surface facing the pawl stop surface, and said second plate camming surface being oppositely disposed from said second plate catch surface.

8. The vehicle lock strike of claim 5 wherein said main plate also includes a mounting wall extending generally perpendicularly from said locking wall.

9. A vehicle lock strike for a latch having a latch bar having a downwardly extending pivoting pawl, the vehicle lock strike comprising,
a stationary main plate including a stationary locking wall with a first vertical catch surface configured to lockably abut said the latch pawl, and
a stationary second plate mounted to said locking wall, said second plate being spaced from said locking wall to form a gap therebetween configured to receive a portion of the pawl and having a second vertical catch surface configured to lockably abut the latch pawl when the pawl is positioned within said gap.

10. The vehicle lock strike 1 claim 9 wherein said second plate has a select vertical height greater than a select vertical height of said locking wall.

11. The vehicle lock strike of claim 9 wherein the pawl including a stop surface, and wherein second plate also has a top end surface, and a camming surface extending to said top end surface, said locking wall catch surface and said second plate catch surface facing the pawl stop surface, and said second plate camming surface being oppositely disposed from said second plate catch surface.

12. The vehicle lock strike of claim 9 wherein said main plate also includes a mounting wall extending generally perpendicularly from said locking wall.
